(19) United States
(12) Patent Application Publication
(10) Pub. No.: US 2008/0030560 A1
(43) Pub. Date: Feb. 7, 2008

(54) Ink jet ink compositions for endorsing applications

(75) Inventors: Thomas W. Martin, Rochester, NY (US); Beth Brusdal, Henrietta, NY (US); Laurie Denton, Ontario, NY (US)

Correspondence Address: FAY SHARPE LLP, 1100 SUPERIOR AVENUE, SEVENTH FLOOR, CLEVELAND, OH, 44114, US

(73) Assignee: Nu-kote International, Inc.

(21) Appl. No.: 10/985,766

(22) Filed: Nov. 10, 2004

(51) Int. Cl. G01D 11/00

(52) U.S. Cl. 347/100

(57) ABSTRACT

The invention is an endorsing application ink jet ink composition containing at least a solvent and a colorant, and further containing a combination of at least one evaporation retardant and at least one absorption accelerator, the ink being characterized by an evaporation rate of less than or equal to 132 mg/sec. for a 2.0 gram sample at 125° C. for five minutes, and an absorption rate of at least 90 μg/sec. for a 5 μL sample on 24# check stock, and to a process for using the same.

The invention relates to ink jet ink compositions, and more particularly to ink jet ink compositions for use in check endorsing applications.

### BACKGROUND

Ink jet recording methods generally entail generating ink droplets and depositing the droplets onto a substrate to create an image, whether in the form of a picture or alpha-numeric print. Printers used in ink jet printing include such technology as piezoelectric printing and drop-on-demand type printing, among others. The equipment, in a very basic sense, includes a cartridge that retains the ink to be used, and a channel for providing the ink from the cartridge to the print head, which has a number of nozzles. Ink droplets are formed and ejected onto the substrate from the nozzles. During printing, the print head is cleaned by a variety of maintenance devices, built into the printer, to keep the nozzle area clear of ink buildup from most ink formulations. When the printer is idle, the print head is moved to a docking station where the nozzles are capped to minimize evaporation of the ink that has been transported from the cartridge to the nozzles but not ejected. This minimizes nozzle clogging and debris on the print head.

In document or check endorsing machines, the ink jet print head is in a fixed position and printing is accomplished by ejecting droplets on to documents being transported by the print head. There are no print head maintenance devices or docking stations contained in this type of machine. While the machine is printing, there is potential for ink to build up on the nozzle face plate and cause streaks or smears in the printed image. Any required cleaning must be done manually by the operator.

When the endorsing machine is idle, ink then sits in the nozzles. Thus, there is considerable potential for the nozzles to clog as the ink dries at the nozzle openings causing the nozzle to fail to print on subsequent activation. This requires removal of the cartridge and manual cleaning. It is highly desirable to keep the need for manual interventions to a minimum with endorsing machines.

For the foregoing reasons, inks need to be formulated to include certain components to help minimize these and other problems. Ink jet ink formulations must exhibit properties that enhance the performance of the ink and the printer, such as stability over time and a tendency not to clog the nozzle. Inks formulated to exhibit relatively slow evaporation and rapid absorption into paper substrates are important for document endorsing applications.

It is important that the ink jet inks intended to produce images from general use ink jet printers produce prints that have high density, are smudge and abrasion resistant, and are lightfast and waterfast. The endorsing of documents also requires that the print be dense, and additionally requires that the print be uniform and sharp, and that there not be traces of ink from prior documents. Further, it is important that ink jet ink used in the endorsing equipment be formulated to absorb into the substrate sufficiently to prevent feathering, which can be caused by ink residue which sits on the document without absorbing or drying properly and rapidly.

Many attempts have been made to address these issues. For example, inks have been formulated to include pigment colorants, which tend to increase the density of the ink. However, when pigments are included in aqueous-based inks, other components must also be added to disperse the pigment, and to reduce the particle size of the pigment so that the print head nozzles are not clogged. These additives typically slow the evaporation rate and reduce the absorption rate of the ink into print substrate materials.

In addition to the foregoing, some ink jet inks have been formulated to include low boiling point additives, which increase the evaporation rate of the ink jet ink and reduce the drying time after printing, or increase substrate penetration rate, which affects the feathering and inter-color mixing of ink jet ink with previously printed inks. Even with these advances in ink jet ink formulations, the inks available today for use in endorsing security-type documents or bank drafts and checks remain unsatisfactory. For example, checks are generally printed on a special grade of paper commonly referred to as check stock. This type of paper differs from other printer paper with regard to the smoothness and the thickness of the paper. Check stock is usually 24 lb. basis weight compared to plain papers which are commonly 20 lb. basis weight. Many of the materials that act as penetrants with 20 lb. papers are ineffective as absorption accelerators with 24 lb. check stock.

Given the foregoing, there remains a need for ink compositions for use in check endorsing equipment, and otherwise, that evaporates slowly off the print head nozzle plate surface while at the same time absorbing rapidly into the check stock or similar substrate. This combination of characteristics minimizes the deposition of ink residue on the nozzle plate of the print head, and thus minimizes the fouling of printed documents. In order to achieve this type of performance, a balance must be achieved between the ink components that affect evaporation and those that affect absorption. This balance is demonstrated by the ink jet ink compositions disclosed hereinbelow.

### SUMMARY OF THE INVENTION

It is an object of the invention to provide an ink jet ink composition for endorsing applications containing at least a humectant and a colorant, and further containing a balanced combination of an evaporation retardant and an absorption accelerant.

It is another object of the invention to provide an ink jet ink for endorsing applications containing a solvent and a colorant, and a combination of at least one evaporation retardant and at least one absorption accelerator, the ink being characterized by an evaporation rate of less than or equal to 132 mg/sec. for a 2.0 gram sample at 125° C. for five minutes, and an absorption rate of at least 90 μg/sec. for a 5 μL sample on 24# check stock.

It is yet another object of the invention to provide a check endorsing process wherein check stock passes vertically, in a continuous manner, past horizontally positioned print head nozzles, and an endorsing ink is ejected horizontally toward the check stock from the nozzles, the ink containing a carrier, a colorant, and a balanced combination of evaporation retardant and absorption accelerator, such that the ratio of retardant:accelerator is from about 3:1 to about 22.5:1, and endorsing the check stock with the ink.

It is yet another object of the invention to provide an endorsing ink that, during idle printer time, does not foul the nozzles or face plate of the print head with dried or crusted ink debris.

These and other advantages of the invention will become more apparent by a fully reading of the following disclosure.

### DETAILED DESCRIPTION OF THE INVENTION

Ink jet inks used to print security type documents, such as bank checks, must exhibit certain performance characteristics. For instance, the ink should exhibit a neutral hue. This characteristic is important because the printed document must be readable by optical scanning equipment used for data storage. An additional parameter of the ink that must be taken into consideration is the optical-density of the ink or the printed image, whether alpha-numeric or that of an object(s). Optical density is defined as the ability of the print to absorb visible radiation and is important because it allows contrast between printed and unprinted areas on a substrate. Preferably the ink jet ink has a high visual optical density. Also important is the text sharpness when performing endorsing-type printing on checks. By text sharpness is meant crisp edges on printed characters. This characteristic of the ink is important with regard to optical scanning of endorsed documents to store data for later retrieval at banking, financial and other institutions.

High Speed Endorser. High speed check endorsing machines present a particular set of performance issues that necessarily require that the ink to be used in the machines is uniquely formulated. For example, conventional ink jet printers include ink jet ink cartridges that are mounted in the vertical position with the nozzles positioned to fire downward. High speed check endorsing machines employ ink jet ink cartridges mounted horizontally with the nozzles positioned to fire horizontally. In the conventional equipment, due to the downward, vertical orientation of the nozzles there is less likelihood of nozzle clogging caused by pooled or dried ink than in the horizontally positioned nozzles of the high speed check endorsing machine. This physical orientation of the nozzles generates a need for ink jet inks intended to be used in high speed check endorsing equipment to evaporate slowly to minimize nozzle clogging.

Another rather unique feature of the high speed check endorsing machine is the path of the check stock through the machine. In an endorsing machine, the check stock travels in a vertical plane, receiving ink jet ink droplets ejected horizontally from the horizontally positioned nozzles. This differs from conventional printers where the substrate travels in a horizontal plane, receiving ink droplets from vertically positioned nozzles placed above the substrate path. The fact that the ink approaches and impinges on the check stock from a horizontal nozzle and that the check stock is vertical requires that the ink absorb rapidly into the check stock to avoid streaking, dripping, or feathering.

Additionally, the substrate in a conventional printer remains stationary during printing, but the check stock in the endorsing machine travels at a high rate of speed, roughly 50 to 150 inches per second, during the printing process. An ink that does not absorb rapidly would, in this instance, be likely to experience streaking, smudging, feathering, and other such print quality diminishing behavior. Adding to the increased difficulties of printing with the endorsing equipment is the fact that the continuous movement of the check stock past the nozzle, which in this machine remains stationary, has a print area only equal to the width of the nozzle area. In conventional printers the opposite occurs, i.e., the paper substrate remains stationary and is indexed forward only after the page is printed, moving the next page into proper print position, and the cartridge/nozzle plate scans back and forth. This further supports the necessity of an ink that absorbs rapidly.

Also with regard to the nozzle plate, the conventional printer is fitted with equipment such that the cartridge nozzle plate is periodically cleaned by a wiper blade in the maintenance station of the machine to remove ink and debris from the nozzle plate surface. This minimizes the potential for transfer of residual ink to subsequent documents. High speed check endorsing machines, however, have no in situ maintenance station to perform the function of periodically and automatically cleaning the nozzle plate. Therefore, the machine operator is required to either clean the nozzle in place, often with a swab, or to remove the entire cartridge from the equipment and clean it using a cleaning wipe.

Finally, during idle time when no printing is being done the cartridge of a conventional printer is moved to a docking station and parked, and the nozzle plate is capped with a rubber boot. This minimizes significantly drying of the ink which would eventually result in clogging of the nozzles. High speed check endorsing machines, however, do not have a docking station or a means to cap the nozzle plate during idle periods. Instead, the operator is relied on to remove the entire cartridge from the endorser and place it in a protective clip with a foam pad to cover the nozzle plate. Obviously, this only occurs during extended down time of the printer. Therefore, the ink used in the high speed endorsing equipment must evaporate slowly to prevent or minimize clogging during those idle periods that are not extended enough to warrant complete cartridge removal.

The foregoing machine characteristics place certain requirements on the formulation of inks for use therein. The necessity of having ink jet inks that evaporate slowly and absorb rapidly is clear.

The Ink Jet Ink. The subject inks used for check endorsing applications have been carefully formulated to exhibit the appropriate evaporation characteristics to address the problems particular to endorsing machines, as just discussed. Therefore, the inks have been formulated to minimize print head nozzle fouling and clogging during those periods of time when the check endorsing equipment is idle. The formulations further exhibit a rapid rate of absorption into the check stock, while printing, to reduce the opportunity for the ink to contaminate the document path and/or to transfer unwanted traces of ink to transported documents. The inks as formulated exhibit an evaporation rate comparable to that of the leading competitors, but also exhibit an absorption rate for the ink jet ink into the check stock that is much faster than that exhibited by those same competitive inks. This allows the inks to achieve much greater productivity in the check endorsing equipment due to the minimizing of potential performance issues during equipment down time, or idle time.

The inks are generally aqueous based inks. While pure water, ultrapure water, i.e., water purified by ion exchange, reverse osmosis or ultrafiltration, or distilled water are preferred, any water may be used. Of course, the use of pure or ultrapure water greatly reduces the chances of fouling the ink with contaminants, or of permitting entrained bacteria to generate mold and bacterial growth in the ink as it sits over time.

In addition, the aqueous base ink may include one or more humectants. The humectants serve to slow evaporation of the ink and reduce the likelihood of nozzle clogging and dried ink debris on the print head nozzle plate. The humectant may also act as co-solvent for the coloring agent(s) contained in the ink. Humectants suitable for use in the inks include but are not limited to water soluble, high-boiling, low volatility organic solvents. Specific examples of these include glycols, such as ethylene glycol, diethylene glycol, triethylene glycol, polyethylene glycol and the like and triol derivatives containing from about 5 to 40 carbon atoms, including glycerol, trimethylolpropane, 1,3,5-pentanetriol, 1,2,6-hexanetriol and the like.

Of these, the preferred humectants are trimethylolpropane, glycerol, and diethylene glycol. The humectant may be used alone or in combinations of one or more, and should be included in the ink jet ink formulation as from about 12.0% to about 30.0% by weight of the total formulation.

The ink further includes one or more coloring agents. The coloring agents may be dyes or pigments, or a combination thereof, as is known in the art. Exemplary suitable dyes are water-soluble dyes, such as direct dyes, acid dyes, basic dyes and reactive dyes. Examples of suitable water soluble dyestuff include: C.I. Direct Black 28, C.I. Direct Black 51, C.I. Direct Black 19, C.I. Direct Black 32, C.I. Direct Black 22, C.I. Acid Black 2, C.I. Acid Black 24, C.I. Acid Black 29, C.I. Acid Black 52, C.I. Acid Black 154, C.I. Direct Yellow 4, C.I. Direct Yellow 26, C.I. Direct Yellow 44, C.I. Direct Yellow 50, C.I. Acid Yellow 9, C.I. Acid Yellow 17, C.I. Acid Yellow 1, C.I. Acid Yellow 23, C.I. Acid Yellow 25, C.I. Acid Yellow 36, C.I. Acid Yellow 42, C.I. Acid Yellow 79, C.I. Food Yellow 3, C.I. Direct Yellow 50, C.I. Direct Yellow 86, C.I. Direct Red 37, C.I. Direct Red 1, C.I. Direct Red 4, C.I. Direct Red 31, C.I. Direct Red 81, C.I. Direct Red 23, C.I. Direct Red 39, C.I. Acid Orange 19, C.I. Acid Orange 20, C.I. Acid Orange 45, C.I. Acid Orange 56, C.I. Acid Red 7, C.I. Acid Red 14, C.I. Acid Red 18, C.I. Acid Red 50, C.I. Acid Red 51, C.I. Acid Red 52, C.I. Acid Red 87, C.I. Acid Red 92, C.I. Acid Red 94, C.I. Acid Red 97, C.I. Acid Violet 15, C.I. Acid Violet 17, C.I. Acid Red 254, C.I. Food Red 9, C.I. Direct Blue 1, C.I. Direct Blue 15, C.I. Direct Blue 6, C.I. Direct Blue 199, C.I. Direct Blue 86, C.I. Direct Blue 78, C.I. Direct Blue 106, C.I. Acid Blue 1, C.I. Acid Blue 15, C.I. Acid Blue 22, C.I. Acid Blue 25, C.I. Acid Blue 27, C.I. Acid Blue 74, C.I. Acid Blue 90, C.I. Acid Blue 91, C.I. Acid Blue 93, C.I. Acid Green 9, C.I. Food Green 2, and the like.

Another component of the ink is a surfactant. Surfactants are compounds that reduce the surface tension of the ink upon being dissolved in the aqueous medium. A reduction in surface tension results in improved substrate surface wetting and image uniformity.

Surfactants that can be used in the ink include but are not limited to ethoxylated acetylenic glycol derivatives, ethylene oxide/propylene oxide condensates, ethoxylated long chain alcohols, and ethoxylated monoalkyl or dialkyl phenols. Preferred surfactants are those commercially available surfactants provided by Air Products, i.e. the Surfynol series, by BASF, i.e. the Pluronic series and Lutensol series.

The ink jet ink formulation for document endorsing further includes a combination of components that serve to enhance the ink performance with regard to evaporation and absorption. This combination of components must be properly balanced to avoid the deleterious affects of not having the ink evaporate slow enough and yet having the ink absorb rapidly enough. The ink must evaporate slow enough to avoid print head clogging while the endorsing machine is idle between print jobs. In addition, the ink must be absorbed into the printed document sheet rapidly enough to avoid feathering or trace transfer of ink to subsequently printed documents, or fouling of the print head. If the ink does not absorb into the substrate fast enough, it will not create print with the necessary density and sharpness.

The first of the two components is a special class of compounds that function as evaporation retardants. The component may be any one of trimethylolpropane, Di(trimethylolpentane), urea, acetylthiourea, allylurea, allylthiourea, N,N′-Dimethylurea, N,N′-Dipropylurea, N-Ethylurea, N-Ethylthiourea and the like. The evaporation retardant should be included in the ink jet ink formulation as from about 2% to about 30% of the ink, based on the total weight of the ink, preferably from about 3% to about 23% of the ink. The evaporation retardant is generally a compound exhibiting a melting point of greater than 30° C. at atmospheric pressure.

The second component of the pair is an absorption accelerator. This component functions to enhance the speed at which the ink is absorbed into the check stock. As was noted earlier, the physical characteristics of the check stock can hinder the quick absorption of more conventional ink jet inks. However, the absorption accelerator, if properly balanced with the evaporation retardant,.can result in ink that is absorbed quickly and efficiently into the check stock to reduce any opportunity for smudging, feathering, bleed, streaks, etc. The absorption accelerator may be any one of t-butanol (2-methyl-2-propanol), t-pentanol (2-methyl-2-butanol), t-hexanol (2-methyl-2-pentanol), 1,4-butanediol, 1,5-pentandiol, 1,6-hexanediol and the like. Of these, t-butanol, t-pentanol and 1,4-butanediol are preferred. This component may be included in the ink jet ink formulation from about 1% to about 5% of the total weight of the ink formulation.

In order to properly balance the amount of the evaporation retardant and the absorption accelerator, special attention must be paid to ink build-up on the nozzle face plate of the print head during periods of extended inactivity of the endorsing machine. In this way, the component content can be balanced for optimum performance. The ratio of retardant to accelerator is about 3:1 to about 22.5:1.

The ink jet inks of the invention may be prepared by any conventional means for ink preparation.

### EXAMPLES

The following examples set forth ink compositions in keeping herewith, as well as the processing parameters used to prepare the same. These examples are provided merely to demonstrate the-invention herein and to enable the skilled artisan to prepare inks in accord therewith. They are not intended to be in any way limiting with respect to the breadth of coverage afforded by the appended claims, it being understood that the skilled artisan will be able to interpret and realize the various permutations of the invention having had the benefit of such examples. Now therefore, the examples are set forth hereinbelow.

In each of the following examples, the ink composition was prepared in accord with conventional methods of ink preparation known to the skilled artisan. Table 1 below sets forth the percent composition of several ink jet inks prepared in accord herewith. The percentages shown are percent composition by weight of the total ink jet ink composition.

TABLE 1
INK COMPOSITIONS

| Component/ | | | | | | | | |
|---|---|---|---|---|---|---|---|---|
| Parameter | Ex. 1 | Ex. 2 | Ex. 3 | Ex. 4 | Ex. 5 | Ex. 6 | Ex. 7 | Ex. 8 |
| Distilled Water | 54.7 | 43.7 | 54.7 | 61.4 | 52.7 | 51.2 | 52.2 | 52.2 |
| Trimethylol- | 22.5 | | 22.5 | | 22.5 | 22.5 | 22.5 | 22.5 |
| propane | | | | | | | | |
| Glycerin | | 6.0 | | 6.0 | | | | |
| Diethylene | | 6.0 | | 6.0 | | | | |
| Glycol | | | | | | | | |
| Urea | | 3.0 | | 3.0 | | | | |
| Bayscript | 13.2 | | 12.0 | 13.2 | 13.2 | 16.5 | 16.5 | 16.5 |
| Special Black | | | | | | | | |
| SP Liquid | | | | | | | | |
| Bayer Special | 0.8 | | 2.0 | 0.8 | 0.8 | 1.0 | 1.0 | 1.0 |
| Red E1171R | | | | | | | | |
| Liquid | | | | | | | | |
| Special Black | | 25.0 | | | | | | |
| HF Liquid | | | | | | | | |
| Pro-Jet Yellow | | 4.0 | | 1.0 | | | | |
| OAM Liquid | | | | | | | | |
| Pro-Jet | | 1.7 | | | | | | |
| Magenta 3B | | | | | | | | |
| OA Liquid | | | | | | | | |
| Proxel GXL | | 0.1 | | 0.1 | | | | |
| Pluronic L64 | 2.4 | | 2.4 | | 2.4 | 2.4 | 2.4 | 2.4 |
| (5%) | | | | | | | | |
| Surfynol S-465 | | 0.5 | | 0.5 | | | | |
| Lutensol A07 | 2.4 | | 2.4 | | 2.4 | 2.4 | 2.4 | 2.4 |
| (5%) | | | | | | | | |
| PEG 400 MW | 2.0 | 2.0 | 2.0 | 2.0 | 2.0 | 2.0 | 2.0 | 2.0 |
| 2-Methyl-2- | 2.0 | 8.0 | 2.0 | 6.0 | 4.0 | 2.0 | 1.0 | |
| Propanol (50%) | | | | | | | | |
| Tetramethylene | | | | | | | | 1.0 |
| Glycol | | | | | | | | |

Table 2 provides physical characteristics of the inks set forth in Table 1. Surface tension has been determined using a Fisher Model 21 Tensiomat. Viscosity was measured with a Brookfield DV-IIT Viscometer using a UL Adapter at 60 rpm. Conductance and pH were determined with a Fisher Accumet Model 50 pH/Conductivity mater.

TABLE 2
PHYSICAL PROPERTIES OF INK JET INKS

| Properties | Ex. 1 | Ex. 2 | Ex. 3 | Ex. 4 | Ex. 5 | Ex. 6 | Ex. 7 | Ex. 8 |
|---|---|---|---|---|---|---|---|---|
| Surface | 39.0 | 40.0 | 36.0 | 41.0 | 39.0 | 42.0 | 41.0 | 39.0 |
| Tension | | | | | | | | |
| (Dyne/cm) | | | | | | | | |
| Viscosity (cP) | 4.16 | 2.92 | 4.33 | 2.55 | 3.95 | 4.22 | 3.99 | 3.93 |
| Conductivity | 2.28 | 4.47 | 2.25 | 4.18 | 2.64 | 2.84 | 2.80 | 2.84 |
| (mS/cm) | | | | | | | | |
| pH | 7.82 | 7.60 | 7.61 | 7.79 | 8.08 | 7.45 | 7.43 | 7.46 |

In addition, the evaporation and absorption characteristics for the ink formulations of Examples 1-8 and for the inks supplied in three different commercially available competitive endorsing application cartridges were determined. Evaporation rate was determined by the difference in mass of a 2.0 gram sample heated at 125° C. for five (5) minutes. The absorption time was determined by applying a 5 μL drop of ink each to five different thicknesses of 24# MICR check stock and measuring the time until the ink appeared dry. The absorption rate was calculated as the mass of ink absorbed into the substrate per unit time. The average of five measurements became the absorption time.

TABLE 3

| | Evaporation | ABSORPTION |
|---|---|---|
| | Rate (mg/sec) | TIME (μg/sec) |
| Ex. 1 | −138 | 93 |
| Ex. 2 | −180 | 183 |
| Ex. 3 | −285 | 128 |
| Ex. 4 | −132 | 192 |
| Ex. 5 | −157 | 89 |
| Ex. 6 | −220 | 152 |
| Ex. 7 | −231 | 119 |
| Ex. 8 | −288 | 147 |
| Eazco | −188 | 98 |
| Symco | −140 | 61 |
| HP40A | −113 | * |

*the HP40A ink did not absorb after 30 minutes.

Wait State Test. The ink compositions, as formulated above, were evaluated with regard to evaporation and absorption characteristics. The testing done is referred to as a “wait state” test because the print quality of the ink is evaluated after graduated length intervals of idle time. The Unisys DP500 Document Endorsing Machine and the NDP1150 Document Endorsing Machine were used to conduct the testing. The DP500 is an older model endorser and tends to be more forgiving with regard to cartridge operation. The NDP1150 is a new model endorser with cartridge positions that are more demanding of inks that exhibit balanced absorption and evaporation rates to provide acceptable print quality after extended idle intervals.

For this testing, each cartridge to be tested was subjected to an initial check print run of two thousand (2,000) checks. The cartridge was then left idle in the machine for the allotted amount of time. This is intended to simulate the amounts of time that may pass between check endorsing jobs at financial institutions. After each interval, an additional print run of two thousand (2,000) checks was endorsed and the image quality was evaluated for acceptability and rated according to the rating scale shown in Tables 4 and 5.

The same protocol was repeated for idle periods or intervals of one, three, five, ten, fifteen and thirty minutes. The cartridges were not cleaned between intervals. If a cartridge did not print to an acceptable quality rating at a given interval, the cartridge was evaluated again at the next interval to verify the test failure. Upon verification, the failed cartridge was cleaned and an additional endorsing run of two thousand (2,000) checks was carried out to validate cartridge functionality.

All endorsed check samples were examined for print quality and given a rating of Good (G—no defects), Acceptable (A—minor imperfections) or Unacceptable (U). In addition, the face plate of each cartridge was evaluated after testing to determine the amount of residual ink left on the face plate after a two thousand (2,000) check endorsing run. A rating was given to each cartridge according to a scale of 1 (small amount of ink) to 5 (large amount of ink). A rating of 2 or 3 is desirable. With a rating of 1 the checks were determined to be unacceptable due to faded or streaked test lines. With a rating of 4 or 5, the checks experienced fuzzy, missing or heavy lines through the test, rendering the checks unacceptable.

The ink formulations prepared according to Example 1, Example 2 and Example 4, as set forth in Table 1, were involved in the testing. In addition, competitive cartridges from Eazco and Symco were also tested. The number in parenthesis indicates what number of several tests on that ink the data relates to. The ink formulations in the Eazco and Symco cartridges were unknown. It is known, however, that the cartridges are provided for endorsing applications.

TABLE 4
DP1150 ENDORSER

| | Print Quality | | | | | | | |
|---|---|---|---|---|---|---|---|---|
| Cartridge | | | | | 10 | 15 | 30 | Print head |
| Type | Initial | 1 min | 3 min | 5 min | min | min | min | Rating |
| Ex. 1 (1) | G | G | G | G | G | A | A | 2 |
| Ex. 1 (2) | G | G | G | G | G | G | G | 2 |
| Ex. 1 (3) | G | G | A | A | A | A | A | 2 |
| Eazco (1) | G | G | U | U | U | U | U | 5 |
| Eazco (2) | G | G | A | A | A | A | U | 5 |
| Eazco (3) | G | A | A | A | U | U | U | 5 |
| Eazco (4) | G | G | G | A | A | A | U | 5 |
| Ex. 2 (1) | G | G | A | A | A | A | U | 5 |
| Ex. 2 (2) | G | G | G | G | G | A | U | 5 |

TABLE 5
DP500 ENDORSER

| | Print Quality | | | | | | | |
|---|---|---|---|---|---|---|---|---|
| Cartridge | | | | | 10 | 15 | 30 | Print head |
| Type | Initial | 1 min | 3 min | 5 min | min | min | min | Rating |
| Ex. 1 (1) | G | G | G | G | G | A | A | 2 |
| Ex. 1 (2) | G | G | G | G | G | G | G | 2 |
| Eazco (1) | G | G | A | A | A | A | A | 2 |
| Symco (1) | G | G | G | G | A | A | A | 4 |
| Ex. 2 (1) | G | G | G | G | G | A | U | 2 |
| Ex. 4 (1) | G | G | A | A | A | G | A | 3 |

It is seen from both Tables 4 and 5 that the Ex. 1 ink consistently produced print with no or only minor imperfections on both endorsing machines. The Eazco ink, in four trials on the DP1150 endorser produced unacceptable print quality, and showed imperfections after three minutes idle time on the more forgiving DP500 endorser. The Symco ink showed imperfections on the DP500 endorser at idle times greater than ten minutes. The Ex. 2 ink did not produce acceptable print on either endorser after a thirty minute wait or idle interval. This would indicate that the balance between evaporation rate and absorption rate is not optimized for the thirty (30) minute wait interval in this ink formulation. The Ex. 4 ink was only tested on the DP500 and it produced acceptable print quality through the entire test.

With regard to the print head ratings, the Ex. 1 ink was consistently rated as 2, which is a desired rating, on both machines. The Eazco and Symco inks were rated poorly, at 4 and 5. The Ex. 2 ink was rated poorly on the DP1150 endorser, but very well at 2 on the DP500 endorser. The example 4 ink was also rated as good, at a rating of 3, in the DP500 endorser.

It is shown by the foregoing that the ink formulated according to Ex. 1 consistently performed well on the endorsing equipment. This is a reflection of the use of an appropriate evaporation retardant and an absorption accelerator that are properly balanced in accord with the teachings herein.

1. An endorsing application ink jet ink composition comprising at least a solvent and a colorant, and further comprising a combination of at least one evaporation retardant and at least one absorption accelerator, the ink being characterized by an evaporation rate of less than or equal to 132 mg/sec. for a 2.0 gram sample at 125° C. for five minutes, and an absorption rate of at least 90 μg/sec. for a 5 μL sample on 24# check stock.

2. The endorsing application ink jet ink composition of claim 1 wherein the colorant is a water-soluble dye.

3. The endorsing application ink jet ink composition of claim a wherein the evaporation retardant is a compound exhibiting a melting point of at least 30° C. at atmospheric pressure.

4. The endorsing application ink jet ink composition of claim 3 wherein the evaporation retardant is selected from the group consisting of trimethylolpropane, di(trimethylolpentane), urea, acetylthiourea, allylurea, allylthiourea, N,N′-dimethylurea, N,N′-dipropylurea, N-ethylurea, and N-ethylthiourea.

5. The endorsing application ink jet ink composition of claim 1 wherein the absorption accelerator is selected from the group consisting of t-butanol, t-pentanol, t-hexanol, 1,4-butanediol, 1,5-pentanediol, and 1,6-hexanediol.

6. The endorsing application ink jet ink composition of claim 1 wherein the ratio of evaporation retardant to absorption accelerator is from about 3:1 to about 22.5:1.

7. An ink jet ink composition comprising an aqueous solvent, a colorant, a humectant, an evaporation retardant and an absorption accelerator, the evaporation retardant and the absorption accelerator being present in a ratio of retardant: accelerator of from about 3:1 to about 22.5:1.

8. The ink jet ink composition of claim 7 wherein the evaporation retardant is present as from about 2% to about 30% by weight of the ink composition.

9. The Ink jet ink composition of claim 7 wherein the absorption accelerator is present as from about 1% to about 5% by weight of the ink composition.

10. The ink jet ink composition of claim 7 wherein the evaporation retardant is selected from the group consisting of trimethylolpropane, di(trimethylolpentane), urea, acetylthiourea, allylurea, allylthiourea, N,N′-dimethylurea, N,N′-dipropylurea, N-ethylurea, and N-ethyithiourea.

11. The ink jet ink composition of claim 7 wherein the absorption accelerator is selected from the group consisting of t-butanol, t-pentanol, t-hexanol, 1,4-butanediol, 1,5-pentanediol, and 1,6-hexanediol.

12. The ink jet ink composition of claim 7 wherein the ink exhibits an evaporation rate, for a 2.0 gram sample at 125° C. for five minutes, of slower than or equal to 132 mg/sec.

13. The ink jet ink composition of claim 7 wherein the ink exhibits an absorption rate, for a 5 μL sample on check stock, of at least 90 μg/sec.

14. A check endorsing process comprising:
a) passing vertically positioned check stock in a continuous manner past the horizontally positioned nozzles of an ink jet print head;
b) horizontally ejecting an endorsing ink from the nozzles of the print head, the endorsing ink comprising a carrier, a colorant and a balanced combination of evaporation retardant and absorption accelerator, such that the ratio of retardant:accelerator is from about 3:1 to about 22.5:1 toward the passing check stock; and
c) endorsing the check stock with the ink.

15. The check endorsing process of claim 14 wherein after thirty minutes of idle time the nozzles of the print head remain substantially clear of debris from the endorsing ink and the face plate of the print head remains substantially clear of residue ink deposits.

16. The check endorsing process of claim 14 wherein the evaporation retardant is selected from the group consisting of trimethylolpropane, di(trimethylolpentane), urea, acetylthiourea, allylurea, allylthiourea, N,N′-dimethylurea, N,N′-dipropylurea, N-ethylurea, and N-ethylthiourea.

17. The check endorsing process of claim 14 wherein the absorption accelerator is selected from the group consisting of t-butanol, t-pentanol, t-hexanol, 1,4-butanediol, 1,5-pentanediol, and 1,6-hexanediol.

18. The check endorsing process of claim 14 wherein the endorsing ink is an aqueous composition containing a water-soluble dye colorant.
